(19) United States
(12) Patent Application Publication
(10) Pub. No.: US 2003/0157923 A1
(43) Pub. Date: Aug. 21, 2003

(54) Mobile station, and apparatus, system and method for management of emergency calls

(76) Inventor: Yasuhiro Tani, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/364,454

(22) Filed: Feb. 12, 2003

(30) Foreign Application Priority Data
Feb. 20, 2002 (JP) 2002-044037

(51) Int. Cl. H04M 11/00; H04Q 7/20

(52) U.S. Cl. 455/404; 455/445

(57) ABSTRACT

The invention comprises emergency call management apparatus (31) and a mobile station (1). The emergency call management apparatus (31) monitors the emergency call generation rate, which is indicative of the rate of generation of emergency calls in a network, and on the basis of the result of this monitoring, transmits state information indicative of the restriction state of communication in that network, when the emergency call generation rate attains a preset condition. The mobile station (1) has emergency number information indicative of a number to be dialed to make an emergency call, and transmits, on the basis of the emergency number information and the received state information, a connection request to the network when the restriction state is a state in which only that emergency call is accepted and the number that has been dialed is the number to be dialed to make that emergency call. This provides a higher probability that an emergency call will be processed in situations in which there is a high rate of generation of emergency calls. This is because in such situations the network only has to process emergency calls.

### BACKGROUND OF THE INVENTION

1. Field of the Invention

The present invention relates to a mobile station and to an apparatus, a system and a method for the management of emergency calls. The invention relates more particularly to a mobile station and to an apparatus, a system and a method for the management of emergency calls when there is a concentration of emergency calls in a communication system.

2. Description of Related Art

In a conventional communication system, the network side (comprising base stations, switching centers, etc.) invariably has to process all calls initiated by mobile stations (i.e., both emergency calls and ordinary calls). However, given their urgency, the processing of emergency calls needs to be given priority. This requirement is particularly pressing in situations where there is a high rate of generation of emergency calls, as for example in the event of a major earthquake, some other natural disaster, or a serious incident or accident. However, in these circumstances systems tend to be subjected to high loads, which means that it is not an easy matter to provide priority processing for emergency calls, and also that there is no guarantee that an emergency call can be processed.

The handling of emergency calls by a method called “preemption” is described in the current IMT-2000 WCDMA system standardized by the 3rd Generation Partnership Project (3GPP). Preemption is a method whereby the network (specifically, a mobile switching center) classifies calls into either calls for which forced release is allowed (ordinary calls) or calls for which forced release is not allowed (emergency calls). In situations such as an insufficiency of resources, preemption maintains resources for emergency calls by forcibly releasing ordinary calls, thereby guaranteeing that emergency calls are connected. However, if resource insufficiency is due to high loads, even preemption processing does not provide an absolute guarantee that an emergency call can be processed.

As related art, JP H5-075536A discloses an emergency call priority connection method. The referenced invention relates to a mobile communication system comprising mobile stations and radio base stations, and in which the mobile stations are designated as being either ordinary class or priority class. A radio base station transmits and receives various kinds of signal to and from mobile stations, which are connected to it via radio channels. When there is congestion within the radio zone of this radio base station, the base station sends restriction information to all mobile stations within its radio zone. When a mobile station receives this restriction information, if it is a priority class mobile station it does not restrict its outgoing calls and continues to originate calls. On the other hand, when an ordinary class mobile station receives the restriction information it stops originating outgoing calls.

In this mobile communication system, ordinary class mobile stations are provided with control means for controlling the operation of each essential part of the mobile station, and with memory means for storing preset emergency call numbers and received restriction information. When the control means detects a number dialed by the user of an ordinary class mobile station, it reads the emergency call numbers and any restriction information from the memory means, and compares the detected dialed number with the emergency call numbers. If the detected dialed number matches an emergency call number, priority is given to performing outgoing call processing for the dialed number that matches the emergency call number, even if restriction information has been received.

This invention ensures that outgoing call processing is performed for emergency calls from ordinary class mobile stations even when the network is congested.

JP 2001-086566A discloses an apparatus for restricting the use of mobile stations. The referenced invention relates to apparatus for restricting the use of mobile stations located in a specific area within a mobile communication service area. The apparatus in question comprises receiving means, selecting means and transmitting means. The receiving means receives identification information pertaining to and transmitted by a base station located in the vicinity of the mobile station use restriction apparatus. The selecting means selects, on the basis of this base station identification information received by the receiving means, a spreading code that differs from the spreading code used by the base station to transmit its identification information. The transmitting means uses the spreading code selected by the selecting means to transmit identification information pertaining to the mobile station use restriction apparatus. A mobile station that moves into the above-mentioned specific area is handed off to the mobile station use restriction apparatus on the basis of this identification information transmitted by the transmitting means.

The mobile station use restriction apparatus further comprises emergency call acceptance means and emergency call redirection means. The emergency call acceptance means accepts emergency calls from the above-mentioned mobile station that has entered and is now located within the specific area. The emergency call redirection means redirects emergency calls accepted by the emergency call acceptance means, to the base station located in the vicinity of the mobile station use restriction apparatus.

This invention enables restrictions to be placed on outgoing calls from or incoming calls to a mobile station such as a cellular telephone, when that mobile station is in a specific location. It also enables specific outgoing calls to be sent even under such restriction conditions.

JP2001-025048A discloses a method and apparatus for connection of priority calls in a radio communication system. The referenced invention relates to a radio communication system designed so that whenever a call is generated by a mobile station, a radio channel is allocated and the call connected to a switching center if the total number of calls at that time is smaller than a specific threshold. The method for connection of priority calls in this radio communication system involves presetting a maximum threshold positioned between a limiting threshold and a design threshold. The so-called limiting threshold is the upper limit, determined by hardware, on the number of calls to which a radio channel can be allocated. The design threshold is the upper limit, determined by channel design, on the number of calls to which a radio channel can be allocated. Even if the above-mentioned total number of calls is greater than the design threshold, if a call that has been generated is found to be a priority call and the total number of calls is found to be less than the maximum threshold, a channel is allocated to that priority call and the call connected to a switching center.

The referenced invention facilitates channel allocation that makes good use of system resources. It is also capable of preventing the loss of emergency calls or general priority calls without sacrificing ordinary calls that are in progress.

JP H7-087569A discloses an emergency message communication method. The referenced invention relates to a method for communicating emergency messages in a cellular system for voice and/or data communications, between mobile stations located in any of the service areas of a plurality of base stations, or between such a mobile station and a terminal station belonging to another public network. This emergency message communication method is implemented by providing the above-mentioned cellular system mobile stations with emergency message transmission capability, and by providing the above-mentioned cellular system base stations with the following capabilities: storage, in an ID number register, of the ID numbers of mobile stations located in a base station's service area; selection, when an emergency message is received, of at least one mobile station currently engaged in non-emergency communication; and temporary restriction of the non-emergency traffic channel communication currently being carried out by the selected mobile station or stations. This emergency message communication method is thereby able to avoid the situation where emergency messages cannot be communicated due to a lack of free channels.

The referenced invention enables an emergency message that has originated from a mobile station to be reliably and preferentially connected and transmitted over a channel without disconnection, etc. of channels being used by other mobile stations.

As related art, JP H10-512432A discloses a method and apparatus for allocating a communication channel in a communication system, the method comprising steps of receiving, from a first user, a signal containing emergency service information; determining whether or not there is an available communication channel; forming an available communication channel by clearing, from a communication channel, a second user who does not have an emergency access class; and allocating the available communication channel to the first user on the basis of the status of the emergency service information.

The referenced invention facilitates prompt access to a radiotelephone communication system and can provide service for priority access calls without unduly loading the system.

There is clearly a need for technology which enables emergency calls to be processed promptly and with priority. It would be desirable to have a technology capable of providing a higher probability that an emergency call will be processed even in circumstances where there is a high rate of generation of emergency calls. It would also be desirable to have a technology capable of processing emergency calls by appropriate utilization of a standardized system.

### SUMMARY OF THE INVENTION

It is therefore an object of the present invention to provide a mobile station and an apparatus, a system and a method for the management of emergency calls, capable of processing emergency calls promptly and with priority.

It is another object of this invention to provide a mobile station and an apparatus, a system and a method for the management of emergency calls, capable of providing a higher probability that an emergency call will be processed even in circumstances where there is a high rate of generation of emergency calls.

It is yet another object of the present invention to provide a mobile station and an apparatus, a system and a method for the management of emergency calls, capable of processing emergency calls by appropriate utilization of a standardized system.

The following description of means for attaining these objects makes use of the referencing numerals and symbols that are used in the subsequent description of preferred embodiments. These referencing numerals and symbols have been added to clarify the correspondence between the statement of the claims and the description of the preferred embodiments. However, these referencing numerals and symbols must not be used to interpret the technical scope of the invention that is set forth in the claims.

In order to attain the above-mentioned objects, the mobile station of the present invention comprises: a storage part (12) for storing state information (20-1) indicative of the restriction state (37) of communication in a network, and emergency call information (17) indicative of a number to be dialed to make an emergency call; and a control part (11) for controlling, on the basis of the state information (20-1) and the emergency call information (17), the transmission of a connection request (e.g., an RRC CONNECTION REQUEST message) to the network when the restriction state (37) is a state in which only that emergency call is accepted and the number that has been dialed is the number to be dialed to make that emergency call.

The mobile station of the present invention also has the following features. There are a plurality of items of emergency call information (17), and each of these items includes emergency rank information (18) expressive of one of a plurality of ranks associated with the corresponding number to be dialed (19). The state information (20-1) contains state rank information indicative of rank and corresponding to the restriction state (37). The control part (11) controls, on the basis of this state rank information and the emergency rank information (18), the transmission of a connection request (e.g., an RRC CONNECTION REQUEST message) to the network when the rank indicated by the emergency rank information (18) associated with a number that has been dialed is greater than the rank indicated by this state rank information.

The mobile station of the present invention further comprises a display part (14). The storage part (12) also stores a message serving to give notification of the state information (20-1). The control part (11) outputs this message to the display part (14) on the basis of the state information (20-1) and the emergency call information (17) when the restriction state (37) is a state in which only emergency calls are accepted and the number that has been dialed is not a number to be dialed to make an emergency call.

In order to attain the above-mentioned objects, the emergency call management apparatus of this invention comprises: a monitoring part (33) for monitoring the emergency call generation rate, which is indicative of the rate of generation of emergency calls in a network; and a management and control part (32) which outputs, on the basis of the result of this monitoring, state information (20-1) indicative of the restriction state (37) of communication in the network, when the emergency call generation rate attains a preset condition (36).

The emergency call management apparatus of this invention also has the following feature: namely, the restriction state (37) is a state in which only emergency calls are accepted.

The emergency call management apparatus of this invention further comprises a condition database (34) for storing, as mutually correlated items, a preset condition (36) for the emergency call generation rate and a restriction state (37).

In order to attain the above-mentioned objects, the emergency call management system of this invention comprises an emergency call management apparatus (31) and a mobile station (1). The emergency call management apparatus (31) monitors the emergency call generation rate, which is indicative of the rate of generation of emergency calls in a network, and on the basis of the result of this monitoring transmits state information (20-1) indicative of the restriction state (37) of communication in the network, when the emergency call generation rate attains a preset condition (36). Mobile station (1) has numbers to be dialed (19) indicative of numbers to be dialed to make an emergency call, and on the basis of these numbers to be dialed (19) and the received state information (20-1) transmits a connection request (e.g., an RRC CONNECTION REQUEST message) to the network when the restriction state (37) is a state in which only emergency calls are accepted and the number that has been dialed is a number to be dialed to make an emergency call.

In order to attain the above-mentioned objects, the method for management of emergency calls of this invention comprises: a step (S11) in which a switch (31) monitors the emergency call generation rate which is indicative of the rate of generation of emergency calls in a network; a step (S17, S32) in which the switch (31) outputs to the mobile station (1), on the basis of the result of this monitoring, state information (20-1) indicative of the restriction state (37) of communication in the network, when the emergency call generation rate attains a preset condition (36); and a step (S34) in which the mobile station (1), on the basis of the state information (20-1) and emergency number information (17) indicative of preset numbers to be dialed to make emergency calls, transmits to the switch (31) a connection request (e.g., an RRC CONNECTION REQUEST message) containing information indicative of an emergency call (e.g., Establishment cause=“Emergency call”) when the restriction state (37) is a state in which only emergency calls are accepted and the number that has been dialed is a number to be dialed to make an emergency call.

The method for management of emergency calls of this invention further comprises: a step (S35) in which the switch (31), on the basis of the connection request (e.g., the RRC CONNECTION REQUEST message), outputs to the mobile station (1) information (e.g., an RRC CONNECTION SETUP message) permitting connection of the mobile station (1); and a step (S36) in which the mobile station (1), on the basis of the information permitting connection (e.g., the RRC CONNECTION SETUP message), transmits to the switch (31) information (e.g., an INITIAL DIRECT TRANSFER message) containing information indicative of an emergency call (e.g., NAS message CM service request=“Emergency call establishment”).

In order to attain the above-mentioned objects, a program pertaining to this invention executes on a computer a method comprising: a step (S11) of monitoring the emergency call generation rate which is indicative of the rate of generation of emergency calls in a network; a step (S17, S32) of outputting to a mobile station (1), on the basis of the result of this monitoring, state information (20-1) indicative of the restriction state (37) of communication in the network, when the emergency call generation rate attains a preset condition (36); a step (S34) of receiving a connection request (e.g., an RRC CONNECTION REQUEST message) containing information indicative of an emergency call (e.g., Establishment cause=“Emergency call”), said connection request having been output by the mobile station (1) in response to the state information (20-1); and a step (S35) of outputting to the mobile station (1), on the basis of the connection request (e.g., the RRC CONNECTION REQUEST message), information (e.g., an RRC CONNECTION SETUP message) permitting connection of the mobile station (1).

The program pertaining to this invention also executes on a computer a method comprising: a step (S32, S21) of receiving, from a switch (31), state information (20-1) indicative of the restriction state (37) of communication in a network; a step (S24) of determining, on the basis of the state information (20-1) and emergency number information (17) indicative of preset numbers to be dialed to make emergency calls, when the restriction state (37) is a state in which only emergency calls are accepted, whether or not the number that has been dialed is a number to be dialed to make an emergency call; and a step (S34) of transmitting, to the switch (31), a connection request (e.g., an RRC CONNECTION REQUEST message) containing information indicative of an emergency call (e.g., Establishment cause=“Emergency call”), when the dialed number is a number to be dialed to make an emergency call.

### BRIEF DESCRIPTION OF THE DRAWINGS

Preferred embodiments of the mobile station and of the apparatus, system and method for management of emergency calls that constitute the present invention will now be described with reference to the accompanying drawings in which:.

FIG. 1 shows the configuration of an emergency call management system which applies the mobile station and the emergency call management apparatus of the present invention;

FIG. 2 illustrates the emergency call information;

FIG. 3 illustrates the condition database;

FIG. 4 is a flowchart showing the operation, in a switching center, of the emergency call management method of the present invention;

FIG. 5 is a flowchart showing the operation, in a mobile station, of the emergency call management method of the present invention; and

FIG. 6 is a flowchart showing the operation, in a mobile station and a switching center, of the emergency call management method of the present invention.

### DETAILED DESCRIPTION OF TIE PREFERRED EMBODIMENTS

Firstly, a description will be given of the configuration of the mobile station and of the apparatus and system for the management of emergency calls of the present invention.

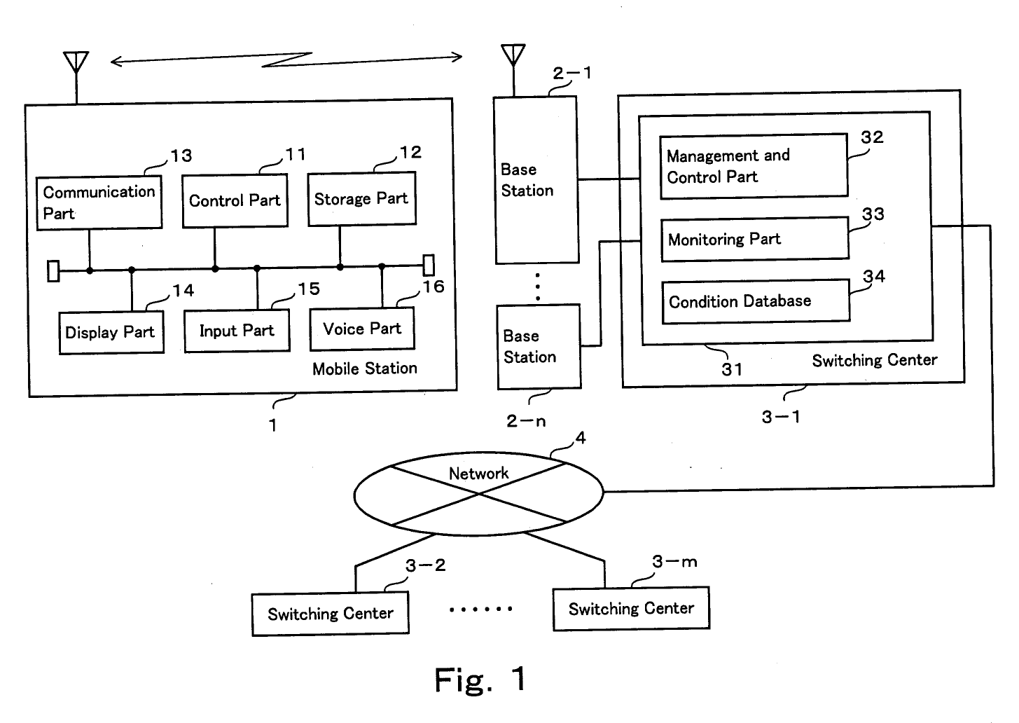

FIG. 1 shows the configuration of an emergency call management system which applies the mobile station and the emergency call management apparatus of the present invention. The emergency call management system illustrated in FIG. 1 comprises mobile station 1, base stations 2-1 to 2-n, and switching center 3-1. The emergency call management system is connected to telecommunication circuits 4. It can also be connected to another network (such as a mobile communication network, a fixed telephone network, etc.).

This invention introduces a novel mobile station state, namely a “dedicated emergency call state”, in which a mobile station can send a connection request to the network only when the number that has been dialed is for an emergency call. In addition, the invention adopts a scheme in which this mobile station state is controllable from the network side.

The invention is therefore capable of providing a higher probability that an emergency call will be processed in circumstances such as a major disaster in which there is a concentration of calls (both emergency calls and ordinary calls). This is because in such circumstances connection requests are issued only for emergency calls and hence the network only has to process emergency calls.

The configuration of the mobile station and of the apparatus and system for the management of emergency calls of the present invention will now be described with reference to FIG. 1.

Mobile station 1 is an information processing terminal belonging to a user and capable of communication while the user is moving. This mobile station is exemplified by cellular telephones (e.g., PDC (Personal Digital Cellular) devices), PDAs (Personal Digital Assistants) and personal computers equipped with cellular telephone functionality. Mobile station 1 comprises control part 11, storage part 12, communication part 13, display part 14, input part 15 and voice part 16.

Control part 11 controls the operation of each part of mobile station 1. Control part 11 is exemplified by a CPU.

Control part 11 also receives, via communication part 13, notification information 20-2 transmitted from base stations 2-1 to 2-n or switching center 3-1 (these will also be termed the “network side” relative to the mobile station) and controls the operation of storing notification information 20-2 in storage part 12. Notification information 20-2 contains state information 20-1 indicative of the state of the network.

On the basis of this state information 20-1, control part 11 determines whether the network is in a state in which only emergency calls are accepted (hereinafter, this will be termed the “dedicated emergency call state”) or is in its ordinary state (hereinafter, this will be termed the “normal state”).

If the network is in the dedicated emergency call state, control part 11 compares the number dialed by the user with the emergency call information 17, which is information relating to numbers to be dialed to make emergency calls, and determines whether or not the number that has been dialed is a number for an emergency call. Emergency call information 17 is stored in storage part 12.

If control part 11 determines that the dialed number is a number for an emergency call, it issues a connection request to the network side via communication part 13.

In this description of preferred embodiments of the invention, the phrase “state of the network” signifies, among others, the operating status and state of use (occupancy) of channels in base stations 2-1 to 2-n, switching center 3-1 or telecommunication circuits 4. In this description of preferred embodiments, the two possible states of the network are “dedicated emergency call state” and “normal state”. Nevertheless, the additional provision of other states is feasible, and if other states are additionally provided, the invention will become responsive to a greater variety of situations.

Notification information 20-2 is the notification information indicated in “Chapter 8 References” of TS 25.331 of 3GPP Release 1999 and is defined by System Information Block type. Namely, notification information 20-2 is various items of information sent to mobile station 1 from the network side (i.e., from base stations 2-1 to 2-n, switching center 3-1, etc.). Mobile station 1 that is not currently engaged in communication is capable of receiving this notification information 20-2. State information 20-1 (i.e., a parameter for emergency calls, which is indicative of whether the network is in a dedicated emergency call state or a normal state) is added to this notification information 20-2.

State information 20-1 transmitted to mobile station 1 from the network side (base stations 2-1 to 2-n, switching center 3-1, etc.) can also be used in conjunction with methods other than those stipulated in the above-mentioned TS 25.331 specification.

Storage part 12 stores emergency call information 17 and notification information 20-2, this latter containing state information 20-1. Storage part 12 also stores character-based or voice-based information to the effect that “due to an emergency situation only emergency calls will be connected”. In addition, storage part 12 stores a variety of information required for the information processing performed by mobile station 1. Storage part 12 is exemplified by a memory.

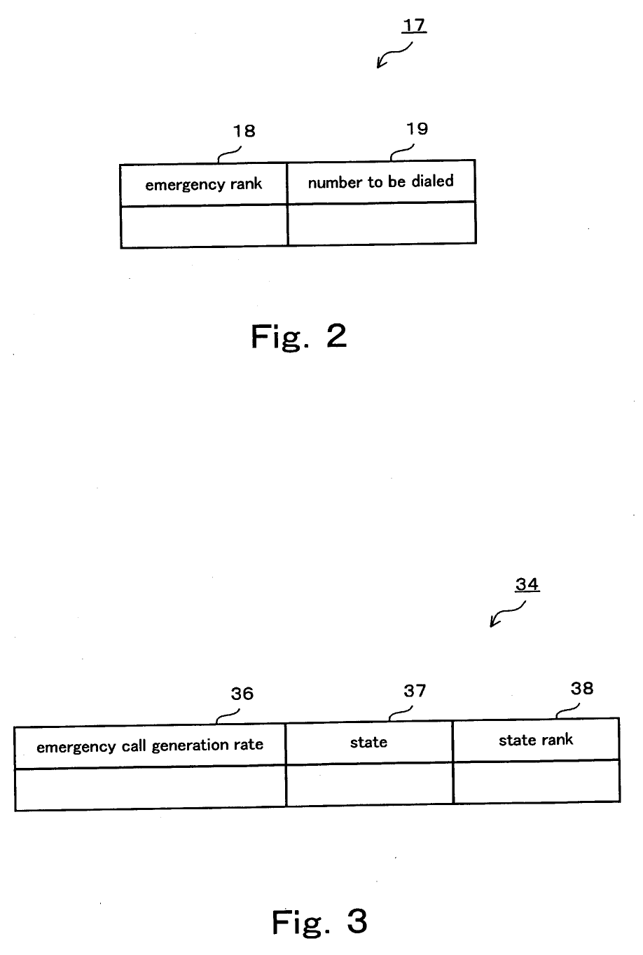

Referring next to FIG. 2, a description will be given of emergency call information 17. Emergency call information 17 comprises emergency rank 18 and number to be dialed 19.

Emergency rank 18 is indicative of degree of urgency. Emergency rank 18 can for example express the degree of urgency in terms of two levels, with a high degree of urgency having an emergency rank of “1” and a low degree of urgency having an emergency rank of “0”. It is also feasible to employ three or more ranks. If this is done, more detailed channel control is possible.

Number to be dialed 19 is a number and/or code specifying the destination and which has to be dialed to set up a connection to the destination. Number to be dialed 19 is exemplified by a telephone number.

Numbers to be dialed 19 associated with an emergency rank of 1 (high degree of urgency) may for example be telephone numbers for contacting police, fire and emergency services, and local government disaster prevention departments. Numbers to be dialed 19 associated with an emergency rank of 0 (low degree of urgency) may for example be telephone numbers for contacting ordinary persons or businesses.

Numbers to be dialed 19 having a low degree of urgency (for example, numbers to be dialed associated with an emergency rank of 0) can alternatively be stored in storage part 12 separately from emergency call information 17. In this case, because emergency rank 18 information can be omitted, memory can be used more efficiently.

Numbers to be dialed 19 associated with a high emergency rank 18 in emergency call information 17 are preferably stored in advance in storage part 12 prior to mobile station 1 being sold to the user, and preferably cannot be altered by the user. If a user were able to make such an alteration, it might be possible for the user to set a high emergency rank for a number having a low degree of urgency. If this were to happen, it would become impossible in the event of an emergency to adequately exclude communications having a low degree of urgency.

An alternative satisfactory arrangement would be as follows. Namely, in the event of an emergency (i.e., in the dedicated emergency call state), the network side (base stations 2-1 to 2-n, switching center 3-1, etc.) transmits, to each mobile station 1, numbers to be dialed 19 with which communication is possible. With this arrangement, information indicative of called parties to which calls are permitted (police, fire and emergency services, etc.) and of their telephone numbers (110, 119, etc.) is preferably inserted in notification information 20-2 at the same time as state information 20-1 is inserted therein. In this case, control part 11 stores these telephone numbers as numbers to be dialed 19 of emergency call information 17 in storage part 12.

Communication part 13 carries out communication between mobile station 1 and another mobile station via telecommunication circuits 4 (and via a base station 2 and a switching center 3).

Display part 14 displays information pertaining to the information processing (including communication) performed by mobile station 1. Display part 14 is exemplified by a liquid crystal display.

Input part 15 is used when the user inputs information. The input part is exemplified by a keyboard.

Voice part 16 serves for voice input by the user and for voice output by mobile station 1. Voice part 16 is exemplified by a speaker and a microphone.

Each of base stations 2-1 to 2-n communicates with communication terminals (including mobile station 1) located within a zone centered around the respective base station, and sets up connections etc. between the communication terminals and telecommunication circuits 4.

Switching center 3-1 communicates with base stations 2-1 to 2-n, controls their operation, and sets up connections etc. between the communication terminals and telecommunication circuits 4. Switching center 3-1 comprises switch 31.

Switching center 3-1 and base stations 2-1 to 2-n have a variety of functions, including a conversion function for converting communication information and control information exchanged between communication terminals and telecommunication circuits 4 to suitable signals and then transmitting these signals; and a control function for managing and controlling radio channel resources and communication terminals within the above-mentioned zones.

Each of switching centers 3-2 to 3-m is a switching center comprising a switch, and serves a network of mobile stations 1 or another network (such as a fixed telephone network, another mobile communication network, etc.).

Telecommunication circuits 4 constitute a network of mobile stations 1 or another network (such as a fixed telephone network, another mobile communication network, etc.).

Switch 31 is exemplified by an apparatus comprising a Radio Network Controller for controlling base stations 2-1 to 2-n and a Mobile Switching Center, this latter being a switch having mobile communication control functions.

Switch 31 comprises management and control part 32, monitoring part 33 and condition database 34.

Monitoring part 33 monitors whether or not the state of the network satisfies a preset condition. This preset condition is the condition for shifting the state of the network to the dedicated emergency call state. This preset condition is stored in condition database 34. If the state of the network satisfies the preset condition, monitoring part 33 sends, to management and control part 32, a “dedicated state shift signal” indicative of the fact that the preset condition has been satisfied.

Condition database 34 stores, as mutually correlated items, emergency call generation rates (these serving as preset conditions) and the state of communication in base stations 2-1 to 2-n and switching center 3-1.

The above-mentioned preset conditions encompass input, by an operator involved with communication control, of requests (or commands) relating to the control of communications. Monitoring part 33 monitors whether or not such a request (or command) has been input. If it has, the above-mentioned operations are performed. An operator request relating to communication control is exemplified by a command, following the occurrence of an accident or a disaster, to restrict (or forcibly terminate) communication of ordinary calls.

Management and control part 32 generates and outputs notification information 20-2. If management and control part 32 receives a “dedicated state shift signal” from monitoring part 33, it changes state information 20-1 of notification information 20-2 to information indicative of the dedicated emergency call state. Management and control part 32 is exemplified by the CPU of switch 31.

FIG. 3 shows condition database 34. Condition database 34 stores, as mutually correlated items, emergency call generation rates 36 (serving as preset conditions), restriction states 37 (indicative of the state of communication in base stations 2-1 to 2-n and in switching center 3-1), and state ranks 38 (indicative of the degree of urgency associated with restriction states 37).

In this preferred embodiment of the invention, the emergency call generation rate is the number of emergency calls generated in unit time by a mobile station. Emergency call generation rate 36 is a reference value R0. Monitoring part 33 compares the rate of generation of emergency calls actually being handled by switching center 3-1 (RE) with this reference value R0. If the actual emergency call generation rate RE is higher than emergency call generation rate 36 (R0), this means that the condition for shifting to the dedicated emergency call state has been satisfied.

It should be noted that the actual emergency call generation rate RE is obtained on the basis of the number of times an Establishment cause value or a CM service request value (to be described hereinafter) is received in unit time. These values are sent by a mobile station 1 when it requests a base station 2-1 to 2-n or switching center 3-1 to connect an emergency call.

Next, a description will be given of the emergency call management method of this invention, this method applying the mobile station and the emergency call management apparatus and system of the invention.

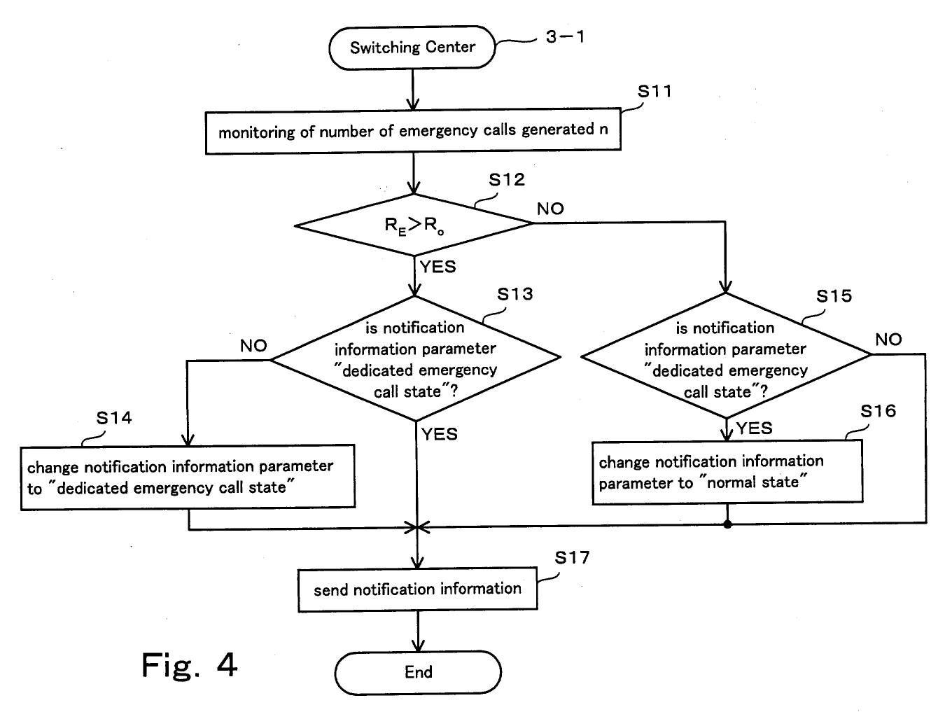

FIG. 4 is a flowchart showing the operation, in switching center 3-1, of the emergency call management method of the invention.

### (1) Formation of Notification Information

(1-1) Step S11

Monitoring part 33 of switch 31 of switching center 3-1 monitors the Establishment cause and CM service request values (to be described hereinafter). Monitoring part 33 constantly checks the number of emergency calls generated n and calculates the emergency call generation rate RE=n/t0, which is the number of emergency calls generated in a preset fixed time interval t0 (i.e., in unit time).

(1-2) Step S12

Monitoring part 33 compares the emergency call generation rate RE with emergency call generation rate 36 (R0). If a disaster or major incident or accident etc. has occurred and emergency calls are generated in concentrated manner, the emergency call generation rate RE will become larger than the reference value R0. When this is the case, monitoring part 33 outputs dedicated state shift signal S to management and control part 32. The processing flow then advances to step S13. Otherwise, processing flow advances to step S15.

(1-3) Step S13

When management and control part 32 of switch 31 of switching center 3-1 receives dedicated state shift signal S, it ascertains whether or not state information 20-1 (i.e., the parameter for emergency calls) of notification information 20-2 which it is currently sending is “dedicated emergency call state”. If state information 20-1 is not “dedicated emergency call state”, the processing flow advances to step S14; otherwise, it advances to step S17.

(1-4) Step S14

If state information 20-1 is not “dedicated emergency call state”, management and control part 32 changes the emergency call parameter to “dedicated emergency call state”. The processing flow then advances to step S17.

(1-5) Step S15

Under ordinary circumstances, or when a temporary concentration of emergency calls has come to an end, the emergency call generation rate RE becomes less than or equal to the reference value R0. Under these circumstances, management and control part 32 ascertains whether or not state information 20-1 is “dedicated emergency call state”. If state information 20-1 is “dedicated emergency call state”, the processing flow advances to step 16; otherwise, it advances to step 17.

(1-6) Step S16

If state information 20-1 is “dedicated emergency call state”, management and control part 32 changes state information 20-1 to “normal state”. The processing flow then advances to step S17.

(1-7) Step S17

Management and control part 32 controls communication by sending notification information 20-2 to mobile station 1.

In addition to state information 20-1, numbers to which emergency calls are permitted (e.g., telephone numbers for contacting police, fire and emergency services) may also be inserted in notification information 20-2 at step S13 or step S14. This makes it certain that only emergency calls will be connected, and prevents a user from tampering with emergency call information 17 in storage part 12.

State information 20-1 of notification information 20-2 may also be changed to “dedicated emergency call state” at step S14 by means of an operator instruction (e.g., by input of a command). This makes it possible to set the state information to “dedicated emergency call state” irrespective of the size relation between the number of emergency calls generated n and a reference number NE. This is effective when it is known in advance that emergency calls will be generated in very large quantities and when an earlier response is desired.

Because switching center 3-1 monitors, at step S11, the number of emergency calls and not the presence or absence of channel congestion, the operation described above (i.e., forming the notification information) is capable of reliably ascertaining whether or not a disaster or a major incident or accident has occurred (whereas such events cannot be distinguished from simple increases in traffic by merely checking whether there is channel congestion). The operation described above can therefore provide an appropriate response to a situation in which only emergency calls should be processed.

Hence mobile station 1 can automatically, without imposing any burden of action on the user, continually recognize whether the network is in a “dedicated emergency call state” or a “normal state”.

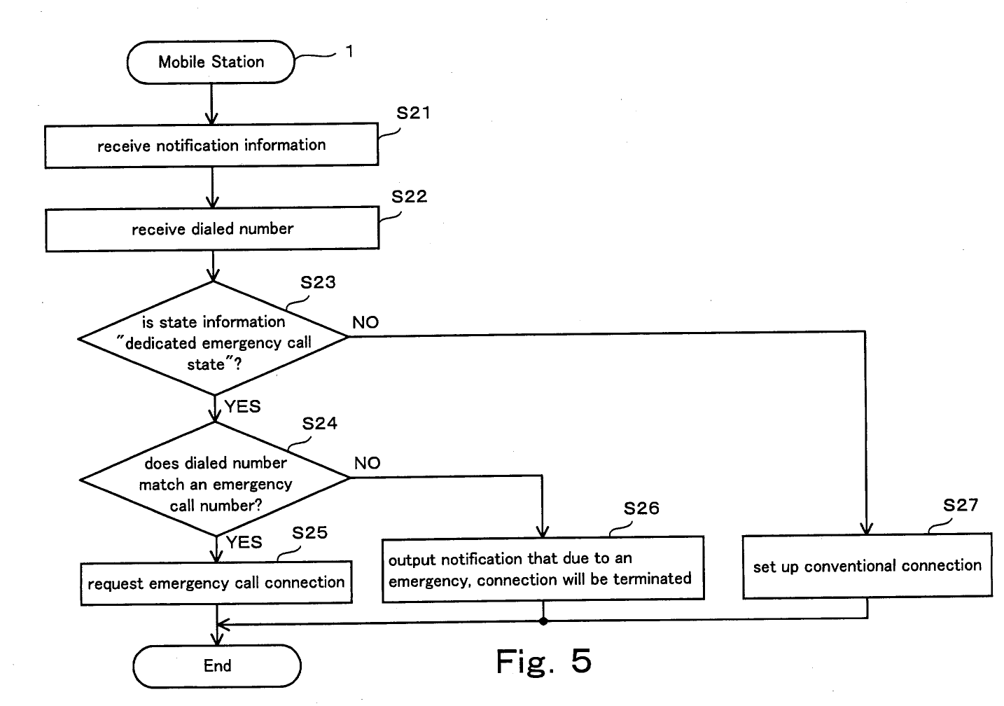

FIG. 5 is a flowchart showing the operation, in mobile station 1, of the emergency call management method of this invention.

### (2) Identifying Notification Information and Dialed Number

(2-1) Step S21

Notification information 20-2 is received via communication part 13 and stored in storage part 12 under the control of control part 11 of mobile station 1.

(2-2) Step S22

In order to make a call, the user inputs dialed number P to mobile station 1 via input part 15. Dialed number P is stored in storage part 12 under the control of control part 11 of mobile station 1.

(2-3) Step 23

Control part 11 determines whether state information 20-1 of notification information 20-2 stored in storage part 12 is “dedicated emergency call state” or “normal state”. If it is found to be “dedicated emergency call state”, the processing flow advances to step S24. Otherwise, processing flow advances to step S27.

(2-4) Step S24

Dialed number P and numbers to be dialed 19 stored in storage part 12 are compared by control part 11. If one of numbers to be dialed 19 matches dialed number P, the processing flow advances to step S25. Otherwise, it advances to step S26.

(2-5) Step S25

Because dialed number P is a number for making an emergency call, control part 11 sends a connection request to the network side.

(2-6) Step S26

Because dialed number P is not a number for making an emergency call, control part 11 outputs from display part 14 (in the case of character-based output) or from voice part 16 (in the case of voice-based output) information to the effect that “due to an emergency situation only emergency calls will be connected”. Alternatively, control part 11 can simply cause a busy tone to be heard.

(2-7) Step S27

Because state information 20-1 is “normal state”, control part 11 sets up a conventional connection.

The state of the network (e.g., “dedicated emergency call state” or “normal state”) can also be transmitted using information other than notification information 20-2.

The operation described above (i.e., identifying the notification information and the dialed number) facilitates automatic selection and connection of only emergency calls in the “dedicated emergency call state”. Because only emergency calls are communicated, emergency calls can be connected promptly, reliably and with priority.

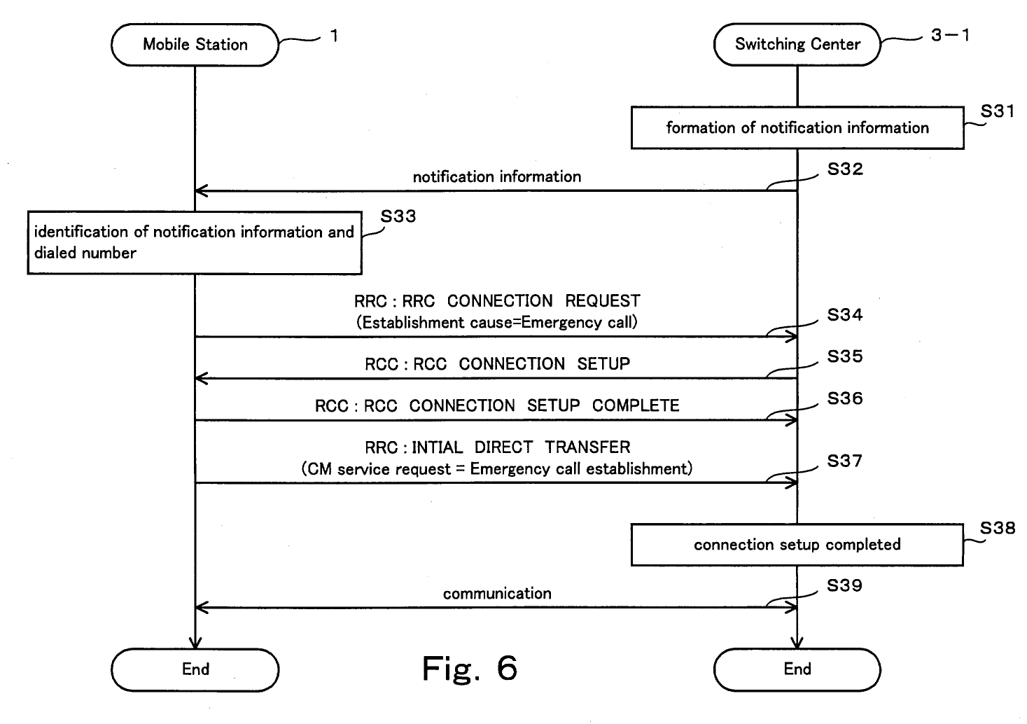

FIG. 6 is a flowchart showing the operation, in mobile station 1 and switching center 3-1, of the emergency call management method of this invention.

“RRC CONNECTION”, which is the protocol used in this operation, is described in 3GPP Release 1999 TS 25 (see http://www.3gpp.org, etc.), and the fundamental portion of this preferred embodiment of the invention employs this protocol. Nevertheless, the present invention is not restricted to this protocol.

### (3) Communication

(3-1) Step S31

Notification information 20-2 is formed by means of the operation previously described in “(1) Formation of notification information”.

(3-2) Step S32

Switch 31 sends notification information 20-2 to mobile station 1, and mobile station 1 receives it.

(3-3) Step S33

Connection of an emergency call is initiated by means of step S25 of the operation previously described in “(2) Identifying notification information and dialed number”.

(3-4) Step S34

When mobile station 1 sends a request to the network for connection of an emergency call, the mobile station sets “Emergency call” as the Establishment cause of the RRC CONNECTION REQUEST message (see 3GPP Release 1999 TS 25.331) and sends the connection request to switch 31. Switch 31 receives the connection request.

(3-5) Step S35

Switch 31 determines, from this Establishment cause, that the RRC CONNECTION REQUEST message is a connection request for an emergency call. Switch 31 then sets an RRC CONNECTION SETUP message indicative of acceptance of the emergency call connection request (see 3GPP Release 1999 TS 25.331) and sends this message to mobile station 1. Mobile station 1 receives the RRC CONNECTION SETUP message.

(3-6) Step S36

On the basis of the RRC CONNECTION SETUP message, mobile station 1 sets an RRC CONNECTION SETUP COMPLETE message indicative of confirmation of acceptance of the connection request, and sends this to switch 31. Switch 31 receives this message.

(3-7) Step S37

Mobile station 1 also sets, in an INITIAL DIRECT TRANSFER message indicative of the commencement of communication, “Emergency call establishment” as the CM service request of its NAS message (see 3GPP Release 1999 TS 25.413 and TS 24.008), and sends this to switching center 3-1. Switch 31 receives this.

(3-8) Step S38

Given the CM service request set in the NAS message, switch 31 can perform final confirmation that the call in question is an emergency call.

(3-9) Step S39

After the connection has been completed, mobile station 1 and switch 31 communicate by means of conventional operations.

Because data indicative of an emergency call, namely, “Emergency call”, is set as the Establishment cause of the RRC CONNECTION REQUEST message in the operation described above (i.e., establishing communication), switch 31 can clearly confirm that a requested call is an emergency call.

In addition, because data indicative of an emergency call, namely, “Emergency call establishment”, is set as the CM service request of the NAS message of the INITIAL DIRECT TRANSFER message, switch 31 can clearly confirm for a second time that a requested call is an emergency call, which makes it more certain still that switch 31 will process only connection requests for emergency calls.

Moreover, because 3GPP specifications are utilized, this invention can be utilized throughout the world.

The dedicated emergency call state is terminated by means of the following operation.

### (4) Termination of Dedicated Emergency Call State

(4-1) While processing emergency call connection requests, switching center 3-1 continues to check the number of emergency calls generated (n) in a fixed time interval.

(4-2) When the disaster or major incident or accident that has occurred is being dealt with, the number of emergency calls generated (n) decreases.

(4-3) When the emergency call generation rate RE becomes smaller than or equal to the reference value R0, state information 20-1 of notification information 20-2 is changed to “normal state”. Alternatively, state information 20-1 is changed to “normal state” by means of an operator instruction.

(4-4) Mobile station 1 confirms that state information 20-1 has changed to “normal state”. As long as this state continues, connection requests are sent to the network even when the dialed number is not a number for making an emergency call.

(4-5) Switching center 3-1 processes connection requests for both emergency calls and ordinary calls (i.e., it processes all connection requests).

The mobile station and the apparatus, system and method for management of emergency calls of the present invention enable emergency calls to be processed promptly and with priority. They also enable emergency calls to be processed accurately by making appropriate use of a system that has been standardized throughout the world.

The present invention is capable of providing a higher probability that an emergency call will be processed in situations in which there is a high rate of generation of emergency calls. This is because in such situations the network only has to process emergency calls.

What is claimed is:

1. A mobile station comprising:
a storage part for storing state information indicative of the restriction state of communication in a network, and emergency call information indicative of a number to be dialed to make an emergency call; and
a control part for controlling, on the basis of said state information and said emergency call information, the transmission of a connection request to said network when said restriction state is a state in which only said emergency call is accepted and the number that has been dialed is the number to be dialed to make said emergency call.

2. A mobile station as claimed in claim 1, wherein:
there are a plurality of items of said emergency call information;
each of said plurality of emergency call information items includes emergency rank information expressive of one of a plurality of ranks associated with the corresponding number to be dialed;
said state information contains state rank information indicative of rank and corresponding to said restriction state; and
said control part controls, on the basis of said state rank information and said emergency rank information, the transmission of a connection request to said network when the rank indicated by the emergency rank information associated with said number that has been dialed is greater than the rank indicated by said state rank information.

3. A mobile station as claimed in claim 1 or 2, further comprising a display part; and wherein:
said storage part also stores a message serving to give notification of said state information; and
said control part outputs said message to the display part on the basis of said state information and said emergency call information when said restriction state is a state in which only said emergency calls are accepted and the number that has been dialed is not a number to be dialed to make a said emergency call.

4. An emergency call management apparatus comprising:
a monitoring part for monitoring the emergency call generation rate, which is indicative of the rate of generation of emergency calls in a network; and
a management and control part for outputting, on the basis of the result of said monitoring, state information indicative of the restriction state of communication in said network, when said emergency call generation rate attains a preset condition.

5. The emergency call management apparatus claimed in claim 4, wherein said restriction state is a state in which only said emergency calls are accepted.

6. The emergency call management apparatus claimed in claim 4 or 5, further comprising a condition database for storing, as mutually correlated items, said preset condition for said emergency call generation rate, and said restriction state.

7. An emergency call management system comprising:
an emergency call management apparatus for monitoring the emergency call generation rate, which is indicative of the rate of generation of emergency calls in a network, and for transmitting, on the basis of the result of said monitoring, state information indicative of the restriction state of communication in said network, when said emergency call generation rate attains a preset condition; and
a mobile station having emergency number information indicative of numbers to be dialed to make an emergency call, and which transmits, on the basis of said emergency number information and said state information that has been received, a connection request to said network when said restriction state is a state in which only said emergency calls are accepted and the number that has been dialed is a number to be dialed to make a said emergency call.

8. A method for management of emergency calls comprising:
a step wherein a switch monitors the emergency call generation rate which is indicative of the rate of generation of emergency calls in a network;
a step wherein said switch outputs to a mobile station, on the basis of the result of said monitoring, state information indicative of the restriction state of communication in said network, when said emergency call generation rate attains a preset condition; and
a step wherein said mobile station, on the basis of said state information and emergency number information indicative of preset numbers to be dialed to make emergency calls, transmits to said switch a connection request containing information indicative of a said emergency call, when said restriction state is a state in which only emergency calls are accepted and the number that has been dialed is a number to be dialed to make a said emergency call.

9. The method for management of emergency calls claimed in claim 8, further comprising:
a step wherein said switch, on the basis of said connection request, outputs to said mobile station information permitting connection of said mobile station; and
a step wherein said mobile station, on the basis of said information permitting connection, transmits to said switch information containing information indicative of said emergency call.

10. A program for the purpose of executing on a computer a method comprising:
a step of monitoring the emergency call generation rate which is indicative of the rate of generation of emergency calls in a network;
a step of outputting to a mobile station, on the basis of the result of said monitoring, state information indicative of the restriction state of communication in said network, when said emergency call generation rate attains a preset condition;
a step of receiving a connection request containing information indicative of an emergency call, said connection request having been output by said mobile station in response to said state information; and
a step of outputting to said mobile station, on the basis of said connection request, information permitting connection of said mobile station.

11. A program for the purpose of executing on a computer a method comprising:
a step of receiving, from a switch, state information indicative of the restriction state of communication in a network;
a step of determining, on the basis of said state information and emergency number information indicative of preset numbers to be dialed to make emergency calls, when said restriction state is a state in which only said emergency calls are accepted, whether or not the number that has been dialed is a number to be dialed to make a said emergency call; and
a step of transmitting, to said switch, a connection request containing information indicative of a said emergency call, when said dialed number is a number to be dialed to make a said emergency call.
